(19) United States
(12) Patent Application Publication
(10) Pub. No.: US 2017/0259093 A1
(43) Pub. Date: Sep. 14, 2017

(54) A FIRE EXTINGUISHER WITH CHECKING FUNCTION

(71) Applicant: Choon Lye Tan, Singapore (SG)

(72) Inventor: Choon Lye Tan, Singapore (SG)

(21) Appl. No.: 15/529,873

(22) PCT Filed: Aug. 3, 2016
(86) PCT No.: PCT/CN2016/092992

§ 371 Date: May 25, 2017

(30) Foreign Application Priority Data
Aug. 13, 2015 (CN) 201510498479.0

(51) Int. Cl. A62C 13/76; A62C 13/00

(52) U.S. Cl. CPC A62C 13/76; A62C 13/006

(57) ABSTRACT

The invention relates to a fire extinguisher with a checking function comprises a fire extinguisher body; a through hole is formed in an upper part of a side surface of the fire extinguisher body; a fixing seat is mounted at the through hole; a checking component is arranged inside the fixing seat; a cavity is machined inside the fixing seat; a groove is formed at a front end of the cavity; a rubber ring for fixing the checking component is mounted inside the groove; a cambered surface mated with the checking component is machined inside the fixing seat; and the checking component is a transparent glass bead. The fire extinguisher has the benefits that the fixing seat is mounted on the fire extinguisher body, a fixing sleeve is mounted on the fixing seat, the glass bead is mounted at the internal cavity of the fixing seat and the fixing sleeve, the through hole is formed in the fire extinguisher body and the fixing seat is fixedly welded on the through hole; thus the fire extinguisher has many advantages that the structure is simple, fire extinguishing agents inside the fire extinguisher can be checked or liquid level and liquid weight can be inspected remotely (transmission of photos and of the latest identification code over a network), an warning about insufficient liquid amount is sent out using a travel controller, and it is convenient and efficient to use the fire extinguisher.

### TECHNICAL FIELD

The invention relates to a fire extinguisher with a checking function.

### BACKGROUND OF THE INVENTION

The fire extinguisher is a light fire extinguishing tool, and can be used for fighting a primary fire and controlling its expansion. Different types of fire extinguishers are suitable for different types of fires, and the structure and the using method of the fire extinguishers are different. When the existing fire extinguishers are used, the situation of internal dry powder or the amount of the internal solution are not known, and thus the fire extinguishers can not be discretely used according to fire behavior, which may make nonreasonable control on the fire tendency, hereby serious consequences may be possibly caused. The fire extinguisher needs to be periodically detected, mainly in terms of whether the internal dry powder of the fire extinguisher is condensed. However, the fire extinguisher with pressure cannot be disassembled to check the dry powder, unless the pressure is released, the valve is taken out and then the fire extinguisher is reassembled and repressurized after checking. Therefore, there are some defects of the traditional fire extinguisher which cannot be remedied, for example, only a small part of the fire extinguisher, instead of the whole fire extinguisher, can be checked, otherwise it is must to perform weighing for checking whether the weight of the liquid extinguishing agent is reduced or detecting the weight, and which need consuming manpower and material resources and the like.

### SUMMARY OF THE INVENTION

Aiming at the defects existing in the above-mentioned problems, the invention provides a fire extinguisher with a checking function.

In order to achieve the above aim, the invention provides a fire extinguisher with a check function, comprising a fire extinguisher body, wherein a through hole is formed in an upper part of a side surface of the fire extinguisher body, a fixing seat is mounted at the through hole, a checking component is arranged inside the fixing seat;
a cavity is machined inside the fixing seat, a groove is formed at a front end of the cavity, a rubber ring for fixing the checking component is mounted inside the groove; a cambered surface mated with the checking component is machined inside the fixing seat; and
   the checking component is made of a transparent glass bead.

As a further improvement of the invention, a fixing sleeve for fixing the checking component is mounted outside the fixing seat, a fixing hole is formed at the front end of the fixing sleeve, and a cambered surface mated with the checking component is machined inside the fixing hole.

Preferably, the fixing seat is in threaded connection with the fixing sleeve.

Preferably, the fixing seat and the fixing sleeve are cylindrical.

Preferably, the checking component is a circular glass bead.

Preferably, the fixing seat and the edge of the through hole are welded.

The invention further provides a checking method for the fire extinguisher with a checking function. Such a checking method is a remote checking method.

The advantages of the invention exist in that the fixing seat is mounted on the fire extinguisher body, a fixing sleeve is mounted on the fixing seat, the glass bead is mounted at the internal cavity of the fixing seat and the fixing sleeve, the through hole is formed in the fire extinguisher body and the fixing seat is fixedly welded on the through hole; thus the fire extinguisher has many advantages such as the structure is simple, and it is convenient and efficient to check the fire extinguishing agents or liquid level and liquid weight inside the fire extinguisher, and the like.

### BRIEF DESCRIPTION OF THE DRAWINGS

FIG. 1 is a front view of the fire extinguisher with a checking function according to embodiment 1.

FIG. 2 is an enlarged schematic view of the position A in FIG. 1.

FIG. 3 is a second schematic structural view of the enlarged schematic view of the position A in FIG. 1.

FIG. 4 is a front view of the fire extinguisher with a checking function according to embodiment 2.

FIG. 5 is an enlarged schematic view of the position B in FIG. 4.

FIG. 6 is an enlarged schematic view of the position C in FIG. 5.

FIG. 7 is an enlarged schematic view of the position D in FIG. 4.

FIG. 8 is a front view of the fire extinguisher with a checking function according to embodiment 3.

FIG. 9 is an enlarged schematic view of the position E in FIG. 8.

FIG. 10 is an enlarged schematic view of the position F of FIG. 8.

FIG. 11 is an enlarged schematic view of the position G in FIG. 8.

In the figures: 1. fire extinguisher body; 2. fixing seat; 3. rubber ring; 4. groove; 5. checking component; 6. fixing sleeve; 7. hose; 8. connection valve; 9. needle valve; 10. filling valve; 11. connecting valve B; 12. floatings; 13. connecting valve C; 14. connecting valve D; 15. metal tube; 16. floating ball; 17. travel detector; 18. magnet.

### DETAILED DESCRIPTION OF THE EMBODIMENT

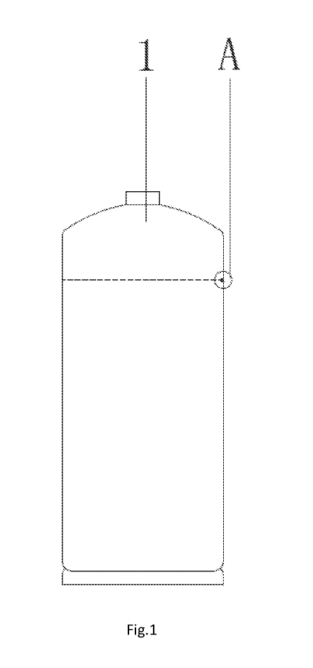

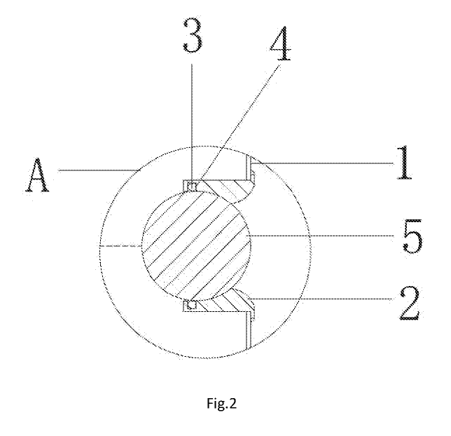

Embodiment 1, as shown in FIGS. 1-2, provides a fire extinguisher with a checking function. As shown in FIG. 1, the position of viewing the liquid level is determined at the liquid level when the bottle is erected, and the position of viewing the fluidity of dry powder is determined at the dry power position arranged at the lower part of the bottle body when the bottle is inverted and all of the dry powder falls to the position at the other end surface of the bottle body. The fire extinguisher comprises a fire extinguisher body 1, and a through hole is formed in the upper part of the side face of the fire extinguisher body 1, a fixing seat 2 is mounted at the through hole, a checking component 5 is arranged inside the fixing seat 2; a cavity is machined inside the fixing seat 2; a groove 4 is formed at the front end of the cavity, and a rubber ring 3 for fixing the checking component 5 is mounted inside the groove 4, a cambered surface mated with the checking component 5 is machined inside the fixing seat 2; the checking component 5 is a transparent glass bead

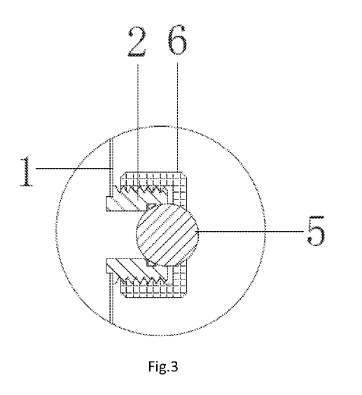

As shown in FIG. 3, a fixing sleeve 6 for fixing the checking component 5 is mounted outside the fixing seat 2, a fixing hole is machined at the front end of the fixing sleeve 6, a cambered surface mated with the checking component 5 is machined inside the fixing hole, the fixing seat 2 is in threaded connection with the fixing sleeve 6, and the fixing seat 2 and the fixing sleeve 6 are cylindrical, the checking component 5 is a circular glass sheet, and the fixing seat 2 and the edge of the through hole are welded.

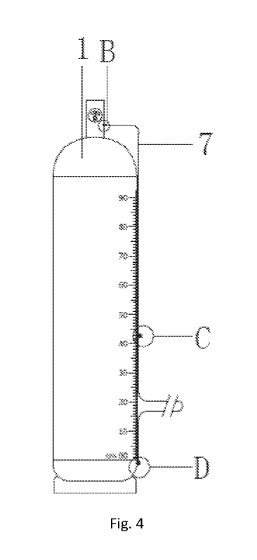

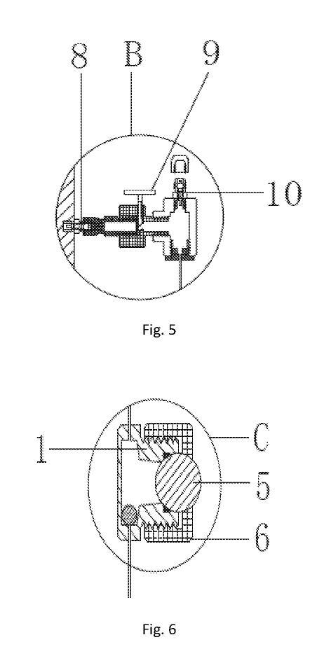

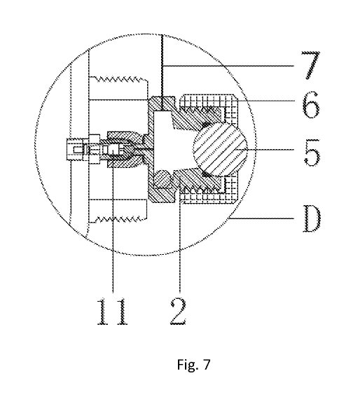

Embodiment 2, as shown in FIGS. 4-7, a hose 7 is arranged between the upper part and the lower side surface of the fire extinguisher body 1, a scale ruler is printed on the side surface of the fire extinguisher body 1, and the hose 7 is connected with the upper part of the fire extinguisher body 1 through a filling device, the filling device comprises a connecting valve A8 which is communicated with the fire extinguisher body 1, and a filling valve 10 communicated with the hose 7 is threadedly mounted at the front end of the connecting valve A8, and a needle valve 9 is mounted in the connecting valve A8. The hose 7 is communicated with the lower part of the side surface of the fire extinguisher body 1 through a connecting valve B11, the connecting valve B11 and the fire extinguisher body 1 are welded, a fixing seat 2 is mounted at the front end of the connecting valve B11 through a lower screw cap, and a fixing sleeve 6 is mounted outside through a bolt, a circular glass bead is mounted at the cavity of the middle of the fixing seat 2 and the fixing sleeve 6, and the lower end of the hose 7 is communicated with the side face of the fixing seat 2. The hose 7 penetrates through the floatable fixing seat, the fixing sleeve 6 is mounted on the fixing base 2 through threads, and the fixing sleeve 6 is mounted on the fixing base 2 through threads, the fixing seat 2 and the cavity of the fixing sleeve 6 are provided with glass beads for observation, and the glass marble beads used for observation are arranged on the cavity of the fixing seat 2 and the fixing sleeve 6, the rear part of the cavity is provided with a colored floating ball 16 or the liquid is intentionally dyed.

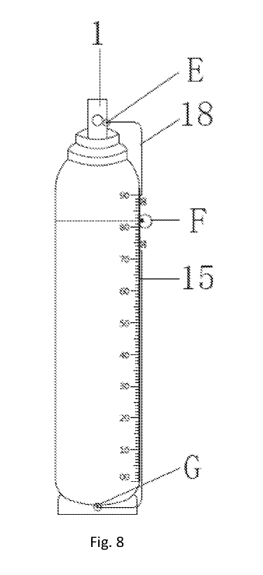

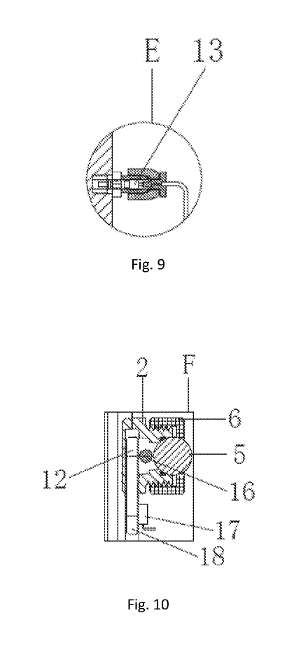

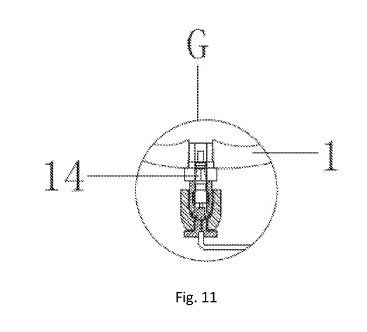

Embodiment 3, as shown in FIGS. 8 -11, a connecting valve C13 communicated with the side surface of the upper part of the fire extinguisher body 1 is mounted at the same, the middle of the lower surface of the fire extinguisher body 1 is provided with a connecting valve D14 communicated with the same. A metal tube 15 is mounted on the connecting valve C13 and the connecting valve D14, and the upper part of the metal tube 15 is machined into a spring shape, a lifting fixing seat 2 is mounted in the middle of the spring shape, a fixing sleeve 6 is mounted outside the fixing seat 2 through threads, and a glass bead 12 is mounted in a cavity between the fixing seat 2 and the middle of the fixing sleeve 6, and a glass bead 12 is mounted in a cavity in the middle of the fixing seat 2 and the fixing sleeve 6, a coloured floating ball 16 or floatings are mounted at the rear part of the cavity, or the glass bead 12 is intentionally dyed, a travel detector 17 and a magnet 18 are mounted at the lower portion of the fixing base 2.

The fire extinguisher according to the invention can be further subjected to remote checking, and is intended to be long-distance checking (such as transmission of photos and of the latest identification code over a network), particularly: an user can take a part of a display checking component of the fire extinguisher into a photo, then is transmitted to a distal engineer through a network together with the latest identification code on the fire extinguisher, and the engineer can know all information of the fire extinguisher after receiving the photos and the identification codes, for example: 1. the appearance condition of the fire extinguisher and the condition of whether the spray pipe is free of barrier; 2. the conditions of the fire extinguishing agent, and the position of the liquid level and whether the weight is sufficient accurately can be precisely informed if the fire extinguisher is a liquid fire extinguisher; and if the fire extinguisher is a dry powder fire extinguisher, it can be determined that whether the flowability of the dry powder is good or not, such information may be precisely transmitted to the customer for confirmation. Meanwhile, engineers can master the use conditions of the sold fire extinguishers in time, know about the use behaviour of the product, and can clearly answer the problem of the user in time. After payment, the password is received, and the customer can obtain the qualified inspection report, so that convenience is provided for inspecting fire extinguishers which are mounted in the ships in the ocean navigation or ordinary buildings, and the users can use the fire extinguishers trustingly.

The above descriptions are only preferred embodiments of the present invention, and are not intented to limit the present invention, it will be apparent to those skilled in the art that various modifications and variations can be made in the present invention. Any modification, equal replacement and improvement and the like made in the spirit and principle of the present invention, without departing from the spirit and principle of the present invention, are intended to be included within the scope of the present invention.

1. A fire extinguisher with a checking function, comprises a fire extinguisher body (1), characterized in that:
a through hole is formed in an upper part of a side surface of the fire extinguisher body (1), a fixing seat (2) is mounted at the through hole, a checking component (5) is arranged inside the fixing seat (2);
a cavity is machined inside the fixing seat (2), a groove (4) is formed at a front end of the cavity, a rubber ring (3) for fixing the checking component (5) is mounted inside the groove (4);
a cambered surface mated with the checking component (5) is machined inside the fixing seat (2); and
the checking component (5) is made of a transparent material.

2. The fire extinguisher with a checking function according to claim 1, characterized in that, a fixing sleeve (6) for fixing the checking component (5) is mounted outside the fixing seat (2), a fixing hole is machined in the front end of the fixing sleeve (6), and hereby a cambered surface mated with the checking component (5) is machined inside the fixing hole.

3. The fire extinguisher with a checking function according to claim 2, characterized in that, the fixing seat (2) and the fixing sleeve (6) are in threaded connection.

4. The fire extinguisher with a checking function according to claim 3, characterized in that, the fixing seat (2) and the fixing sleeve (6) are cylindrical.

5. The fire extinguisher with the check function according to claim 1, characterized in that, the checking component (5) is a circular glass bead.

6. The fire extinguisher with a checking function according to claim 1, characterized in that, the fixing seat (2) is welded with the edge of the through hole.

7. An inspection method for a fire extinguisher with a checking function according to claim 1, characterized in that, the inspection method is a remote inspection method.

8. An inspection method for a fire extinguisher with a checking function according to claim 2, characterized in that, the inspection method is a remote inspection method.

9. An inspection method for a fire extinguisher with a checking function according to claim 3, characterized in that, the inspection method is a remote inspection method.

10. An inspection method for a fire extinguisher with a checking function according to claim 4, characterized in that, the inspection method is a remote inspection method.

11. An inspection method for a fire extinguisher with a checking function according to claim 5, characterized in that, the inspection method is a remote inspection method.

12. An inspection method for a fire extinguisher with a checking function according to claim 6, characterized in that, the inspection method is a remote inspection method.

13. The fire extinguisher with a checking function according to claim 2, characterized in that, the fixing seat (2) is welded with the edge of the through hole.

14. An inspection method for a fire extinguisher with a checking function according to claim 13, characterized in that, the inspection method is a remote inspection method.
